(19) United States
(12) Patent Application Publication
(10) Pub. No.: US 2024/0237656 A1
(43) Pub. Date: Jul. 18, 2024

(54) TRANSFER DEVICE FOR LOADING AND/OR UNLOADING A TREATMENT UNIT FOR FOOD

(71) Applicant: MIWE Michael Wenz GmbH, Arnstein (DE)

(72) Inventors: Markus Keller, Retzstadt (DE); Andreas Thees, Gaenheim (DE); Ronny Leppich-Rudloff, Karlstadt (DE)

(73) Assignee: MIWE Michael Wenz GmbH, Arnstein (DE)

(21) Appl. No.: 18/556,694

(22) PCT Filed: Apr. 14, 2022
(86) PCT No.: PCT/EP2022/060123

§ 371 Date: Oct. 23, 2023

(30) Foreign Application Priority Data
Apr. 22, 2021 (DE) 102021110295.2

(51) Int. Cl. A21B 3/07

(52) U.S. Cl. CPC A21B 3/07

(57) ABSTRACT

The invention relates to a transfer device for loading and/or unloading a food treatment unit (1a, 1b), with a movable transfer trolley (3) which has a support device (20, 22) for at least one loading rack (27, 28) or for at least one product carrier, with a drive (19) for moving the transfer trolley (3), and with at least one actuator (21, 23) arranged on the transfer trolley (3), which actuator is configured to move the loading rack (27, 28) or the product carrier into a receiving device (25, 26), located on a first side (13) of the transfer trolley (3), of the food treatment unit (1a, 1b) and to remove it therefrom.

The task of the invention is to make the loading and/or unloading of a food treatment unit (1a, 1b) particularly flexible, time-efficient and cost-efficient.

This task is solved in that the transfer trolley (3) and the actuator (21, 23) are configured to additionally move the loading rack (27, 28) or the product carrier into at least one second receiving device (25, 26) located on a second side (14) of the transfer trolley (3) and to remove it therefrom.

### TECHNICAL FIELD

This application relates to a transfer device for loading and/or unloading a food treatment unit, and more particularly to a transfer device for loading and/or unloading a baking oven.

### BACKGROUND

A transfer device for loading and/or unloading a food treatment unit has a movable transfer trolley, a drive for moving the transfer trolley, and an actuator. The transfer trolley is a movable trolley that includes a support device carrying at least one loading rack or a product carrier. Such devices for facilitating the transfer of food products to a treatment unit are often used in the baking trade. Here, dough pieces that are proofed in a proofing chamber and baked in an oven are placed on baking trays for the processing steps. The baking trays constitute the product carriers. Multiple baking trays may be arranged in loading racks, which can then be moved with all baking trays accommodated therein. The actuator is arranged on the transfer trolley and is configured to move the loading rack or the product carrier from the transfer trolley into a receiving device of the food treatment unit and to remove the loading rack or product carrier therefrom.

Such a transfer device for loading and/or unloading a treatment unit (baking oven) is known from FR 1 458 682 A. The transfer device disclosed therein allows simultaneous transfer of several baking trays into or out of a baking oven. The baking trays are arranged one above the other on support rails of a loading rack referred to as a frame. The frame is detachably arranged on a manually movable transfer trolley. The frame can be lifted using a manually operated lifting system arranged on the transfer trolley and can be placed in the baking chamber of the baking oven.

A further transfer device and method for loading and/or unloading a treatment unit is known from DE 10 2012 003 799 A1, which describes an apparatus which includes a baking oven, at least one loading trolley and at least one handling device. The loading trolley accommodates a charging rack, referred to as a loading rack, in which a plurality of product carriers are arranged. The loading trolley can be coupled to the baking oven using the handling device. The handling device is used to transfer the charging rack with the product carriers between the baking oven and the loading trolley when the loading trolley is coupled to the baking oven. The handling device can be integrated on the baking oven or on the loading trolley. The handling device can have a lifting device and a displacement device for moving the charging rack. A driver can be provided, which executes a vertical and/or a horizontal movement. The loading trolley has guide rails and the baking oven has insertion rails. The charging rack has running wheels that roll on the guide rails and insertion rails so that the charging rack can be moved between the loading trolley and the baking oven. A further development of such a transfer device is described in DE 10 2015 104 517 B3.

The prior art transfer devices allow for coupling with one side of the loading or transfer trolley for loading and unloading the treatment devices with loading racks. Loading or transfer trolleys are designed to be moved manually.

WO 2006/097448 A1 discloses an apparatus for storing, treating and dispensing food products, in which a vertically movable carriage on a vertical rail has a horizontally movable transport mechanism which transports individual product carriers from stationary conveyor belts on one side of the rail to stationary conveyor belts of a tunnel oven on the other side of the rail. The device described in WO 2006/097448 A1 is very inflexible due to the stationary conveyor belts.

### SUMMARY OF THE INVENTION

It is desirable to make the loading and/or unloading of a food treatment unit particularly flexible, time-efficient and cost-efficient.

A transfer device for loading and/or unloading a food treatment unit includes a movable transfer trolley which has a support device for at least one loading rack or for at least one product carrier, a drive for moving the transfer trolley, and an actuator which is arranged on the transfer trolley and is configured to move the loading rack or the product carrier into a receiving device, located on a first side of the transfer trolley, of the treatment unit assigned to the transfer trolley and to remove the loading rack or the product carrier therefrom.

In order to solve the above task, the transfer trolley and the actuator are configured to additionally move the loading rack or the product carrier into at least one second receiving device located on a second side of the transfer trolley and to remove the loading rack or the product carrier therefrom.

In other words, the transfer trolley and the actuator described herein may transfer the loading rack or product carrier into or remove the loading rack or product carrier from the second receiving device not only via one side of the transfer trolley but via at least two sides of the transfer trolley. It is therefore possible to move a loading rack or a product carrier in and out via several sides of the transfer trolley. The second receiving device can, for example, be arranged on a loading trolley. In contrast to the prior art, it is thus proposed not to drive the loading trolley directly in front of the treatment unit in order to move the loading rack back and forth between the loading trolley and the treatment unit. Instead, a special transfer trolley, which acts as autonomously and automatically as possible, takes the loading rack or product carrier from the loading trolley and transfers the loading rack or product carrier to the treatment unit.

By being movable along the floor surface, i.e., essentially horizontally, the transfer trolley can be moved to different positions in which the transfer trolley picks up or delivers product carriers. When the transfer trolley is positioned in a loading position in front of a loading opening of a treatment unit, e.g., a baking oven, the loading rack or product carrier can be moved into and removed from the receiving device of the treatment unit via the first side of the transfer trolley. The transfer trolley can automatically approach treatment units or loading trolleys with the second receiving device at other transfer positions, the second receiving device being located either on the first side or the second side of the transfer trolley. The actuator for moving the product carrier or the loading rack can act in both directions.

The drive for moving the transfer trolley horizontally can be arranged on the transfer trolley itself. In particular, the drive can be designed as an electric motor. Alternatively, a drive mechanism (e.g., a drive chain) can be provided on the floor, which is coupled to the transfer trolley and moves the transfer trolley to the intended positions.

The second side of the transfer trolley can be opposite the first side of the transfer trolley. In this case, the loading rack or product carriers can be guided on guide rails of the transfer trolley, from which the loading rack or product carriers can be pushed out to either side. Alternatively, however, the second side can also be adjacent to the first side. The actuator is arranged and designed in or on the transfer trolley in such a way that the loading rack or the product carrier can be transferred with the actuator either via the first side or via the second side of the transfer trolley. Transferring means in particular pushing in, pulling in, pivoting in and/or lifting in as well as pushing out, pulling out, pivoting out and/or lifting out. For example, the loading rack or the product carrier can be pulled into the transfer trolley by the actuator from the second receiving device via the second side of the transfer trolley and pushed out of the transfer trolley into the receiving device of the treatment unit by the actuator via the first side, and vice versa. The actuator can be of particularly simple design if the first side and the second side are opposite each other.

The transfer device described here enables the transfer trolley to be moved automatically to different positions and to pick up or deliver loading racks or product carriers from several sides and thus from different directions. This makes the transfer of loading racks or product carriers with, for example, unbaked dough pieces between the loading trolley and the baking oven and fully baked goods back to the loading trolley, with which the baked goods are transported for packaging or sale, very flexible and decoupled from one another in terms of time. The same applies to the loading and unloading of other food processing equipment such as proofers, refrigerators and freezers, or even steam cookers or combi steamers. Overall, costs can thus be saved with the transfer device.

In practice, the transfer device can have a guiding device with which the transfer trolley is guided along a travel path. The drive and the guiding device allow the transfer trolley to be automatically moved, in particular between one or more second receiving devices and one or more food treatment units.

In practice, the guiding device may include a rail, a truss, a conductor track, or a navigation system, or a combination thereof. The drive for moving the transfer trolley may be located on the transfer trolley itself, and the transfer trolley includes a mechanism for rolling or sliding on a floor surface.

If the guiding device is a rail, the transfer trolley has, for example, rollers that roll on the rail and provide lateral guidance. A system consisting of a rail and rollers is particularly simple, robust and reliable. In this case, the rail defines a predetermined travel path of the transfer trolley. The rail can be fixed to the floor, to the treatment unit, or to the ceiling of the room in which the transfer device is located.

If the guiding device is designed as an electrical conductor track, the conductor track can be provided in the floor. A corresponding sensor arranged on the transfer trolley detects the course of the conductor track and communicates with a control unit for steering the transfer trolley. When the transfer trolley is moved, the control unit controls the drive so that the transfer trolley follows the electrical conductor track.

If the guiding device is designed as a navigation system, the transfer trolley has greater freedom of movement. In principle, any known navigation system can be used. In particular, grid navigation or laser navigation can be used. A method such as laser navigation, in which the location is determined and obstacles are detected by scanning the surroundings, has the advantage in that laser navigation does not require additional installations such as electrical conductor loops and can be used in existing food processing plants without costly structural retrofitting. In practice, this method is known as SLAM (Simultaneous Localization and Mapping) and is used for simultaneous position determination and map generation. By scanning the environment with laser beams, the environment is captured (mapping) and the position in the environment is determined. Certain properties of the scanned surfaces, in particular of the treatment unit and the unit on which the second receiving device is arranged, facilitate position determination and navigation. In addition, mechanical guiding elements can be arranged, in particular near the working positions, which guide the movement of the transfer trolley.

The automatic guiding device enables the transfer of loading racks or product carriers between, for example, the loading trolleys with the second receiving device and the treatment unit to be carried out fully automatically using the transfer device. The staff is relieved of these tasks and can con-centrate, for example, on preparing the food.

In practice, the transfer trolley with the guiding device can be moved essentially in a horizontal direction transverse to the direction in which the actuator acts and moves the loading rack or the product carrier. If the loading of the treatment unit and thus the direction of action of the actuator defines the longitudinal direction, the direction of movement specified by the guiding device can be the transverse direction. The direction of action of the actuator is horizontal and oriented parallel to the side of the treatment unit in which a door to a treatment chamber of the treatment unit is provided. The transfer device can thus be moved to the left and right in front of the loading opening of the treatment unit. The transfer trolley, which can be moved horizontally and transversely, allows the transfer and loading positions to be arranged next to each other on both sides of the travel path. This results in a simple and cost-effective setup, easy control and great flexibility.

In practice, the transfer trolley may have a frame. The frame may extend over at least the height and width of the treatment chamber of the treatment unit when surrounding the transfer trolley. The side facing the treatment unit and the opposite side of the transfer trolley may form the first side and the second side, respectively, and may have an open configuration. In other words, the transfer trolley is formed as a portal accessible from two opposite open sides. In particular, the dimensions of the side of the treatment unit with the door for the treatment chamber and the frame can be approximately congruent.

For loading and/or unloading the treatment unit associated with the transfer device, the frame can be positioned with a first open side of the treatment unit at the loading opening of the treatment unit and the loading rack or product carrier is inserted into or removed from the treatment unit using the actuator through the loading opening on the first side of the transfer device. Also, via the first open side of the frame or alternatively via a second open side of the frame, the loading rack or the product carrier can be transferred between the transfer trolley and the second receiving device (e.g. loading trolley).

The support device for the loading rack or the product carrier can be arranged in the frame of the transfer trolley. The support device can have, for example, two guide rails which are attached to two opposite sides of the frame and allow the loading rack or the product carrier to be moved in a longitudinal direction of the loading rack or the product carrier. The loading rack or the product carrier may have sliding surfaces or rollers that rest on the guide rails.

The transfer trolley may have rollers underneath the frame for traversing.

In practice, the actuator for transferring the loading rack or the product carrier can have at least one drive and at least one driver. The driver may be a projection engageable with an abutment on the loading rack or product carrier. Additionally or alternatively, the driver may be an anti-slip surface engageable with a surface of the loading rack or product carrier. The driver can be moved by the drive in the direction of the first side and the second side of the transfer trolley, such that the loading rack or product carrier is displaced in the support device in the direction of the first side and the second side of the transfer trolley when the protrusion is engaged with the abutment.

A sensor and a control unit can additionally be assigned to the actuator for transferring the loading rack or the product carrier. The sensor, which can be a basically known optical sensor, for example, monitors the position of the driver and transmits data relating to the position to a control unit. The control unit controls the drive of the actuator depending on the position of the driver and the transfer to be made into or out of the transfer trolley. This design enables the transfer process to be carried out and monitored completely automatically.

The system described herein further relates to a treatment device with at least one food treatment unit, which includes at least one treatment chamber with a receiving device for receiving at least one loading rack or a product carrier, with at least one automatically opening and closing door for the treatment chamber, and with at least one second receiving device associated with the treatment unit for receiving the loading rack or the product carrier. The treatment device further includes the previously described transfer device for loading and/or unloading the treatment unit.

The receiving device of the treatment unit can be designed in particular as loading rails, which are arranged on two opposite inner walls of the treatment chamber and are at the same height as the guide rails, which are arranged in the transfer trolley and form the support device. The loading rack runs on the rails with rollers or sliding shoes and can be pushed by the actuator from the guide rails of the support device onto the loading rails in the treatment chamber of the treatment unit and pulled down therefrom. Alternatively or additionally, the support device of the treatment unit can also be designed as a simple floor in the treatment chamber, or be formed by rollers on which rails on the loading rack can be moved.

The door for the treatment chamber is arranged at the loading or charging opening of the treatment unit. The door can be opened and closed automatically so that loading and/or unloading of the treatment unit through the loading opening can be carried out fully automatically with the transfer device. The door for the treatment chamber can, for example, be pivotably mounted on the treatment unit via a joint. A drive, in particular an electric motor or a pneumatic cylinder, can generate a force which pivots the door for the treatment chamber about the axis of rotation of the joint and thus opens or closes the door automatically. The drive opening and closing the door can be controlled by electrical signals for opening and closing. The signals are sent to the drive from a control unit controlling the door for the treatment chamber when the transfer trolley is outside the swivel range of the door for the treatment chamber. The position of the transfer trolley can be determined, for example, by a sensor that communicates with the control unit for the door for the treatment chamber. The sensor can communicate with the control unit either wirelessly or by wire.

In practice, the second receiving device may be arranged on at least one loading trolley, as mentioned above. Alternatively, the second receiving device can also be arranged on at least one cooling unit or one proofing unit. Loading trolleys, cooling units and proofing units are basically known from the prior art. The second receiving device can be movable or stationary in one location.

In practice, the second receiving device may be associated with a transfer position in which the second receiving device is positionable on the first or second side of the transfer trolley for performing the transfer of the loading rack or product carrier. In the transfer position, the loading rack is movable back and forth between the second receiving device and the support device of the transfer trolley. In practice, a plurality of transfer positions may be provided, as well as a plurality of loading positions for different treatment devices. The transfer trolley is thus movable between various predetermined positions, loading positions and transfer positions, and can flexibly transfer food to be treated without any need for personnel into and out of the treatment devices onto the loading trolleys for onward transportation. In this way, for example, the loading of several loading trolleys with dough pieces to be baked can be decoupled in terms of time from the baking process. The loaded loading trolleys can be parked by the personnel at different transfer positions and the automatic transfer of the dough pieces into the oven is carried out by the transfer trolley without the need for personnel.

The same applies to the removal of the finished baked goods, which are automatically removed from the treatment equipment (oven) by the transfer trolley at the end of the baking process and transferred to a loading trolley. Further transport can then be carried out again by an employee at the ap-propriate time. The same applies, of course, to food products and treatment equipment other than baking ovens.

A treatment device may have a plurality of identical or different treatment units (oven, proofer, freezer).

If the second receiving device is arranged on a trolley with rollers on the underside, the trolley with the second receiving device can in practice be moved into the transfer position and locked there. The locking can be done, for example, by positioning the rollers in a trough in the floor at the transfer position. When the transfer trolley has approached the trolley with the second receiving device and the actuator transfers the loading rack, the dead weight of the trolley carrying the second receiving device prevents the trolley from moving out of the trough. However, the trolley with the second receiving device can also be guided into the predetermined transfer position by any other guide mechanism (guide rails or guide plates) and fixed in the transfer position by any locking mechanism or brakes.

The system described herein further relates to a method for automatically loading and unloading a treatment unit having a first receiving device. The method for automatically loading and unloading the treatment unit includes the following:
positioning a second receiving device in a transfer position;
automatic movement of a transfer trolley to the transfer position;
transfer of a loading rack or a product carrier between the transfer trolley and the second receiving device in the transfer position with an actuator arranged on the transfer trolley;
automatic opening or closing of a door for the treatment chamber-provided on the treatment unit;
automatic movement of the transfer trolley to a loading position;
transfer of the loading rack or product carrier between the treatment unit and the transfer trolley in the loading position using the actuator arranged on the transfer trolley.

As explained above, the loading rack or the product carrier is not transferred out of the loading trolley into the oven (or another treatment unit) but is taken over by an automatically driven transfer trolley which includes the actuator and a drive and can thus move automatically and without personnel effort to the various transfer positions and treatment units and in this way convey the product carriers/loading racks to the desired treatment and then transfer the product carriers/loading racks to loading trolleys for onward transport. Again, it is desirable that the transfer can be carried out by the separate transfer trolley via at least two sides of the transfer trolley.

### BRIEF DESCRIPTION OF DRAWINGS

Further practical embodiments and advantages of the system described herein are set forth below in connection with the drawings. In the drawings:

FIG. 1 shows a food treatment device with a transfer trolley in an oblique top view;

FIG. 2A shows a view of the treatment device corresponding to FIG. 1 with the transfer trolley in a transfer position;

FIG. 2B shows a view of the treatment device corresponding to FIG. 1 with the transfer trolley in a waiting position;

FIG. 2C shows a view of the treatment device corresponding to FIG. 1 with the transfer trolley in a loading position;

FIG. 2D shows a view of the treatment device corresponding to FIG. 1 during closing of the treatment unit;

FIG. 3A shows an actuator for transferring a loading rack arranged on the transfer trolley in a first position in an oblique front view;

FIG. 3B shows the actuator from FIG. 3A arranged on the transfer trolley in a second position in an oblique front view;

FIG. 4A shows a loading trolley with loading rack at the beginning of the transfer into the transfer trolley in a view from the front at an angle;

FIG. 4B shows a view corresponding to FIG. 4A when the actuator of the transfer trolley grips the loading rack;

FIG. 4C shows a view corresponding to FIG. 4A with the loading rack mostly located in the transfer trolley;

FIG. 4D shows a view corresponding to FIG. 4A with the loading rack completely located in the transfer trolley.

### DETAILED DESCRIPTION OF VARIOUS EMBODIMENTS

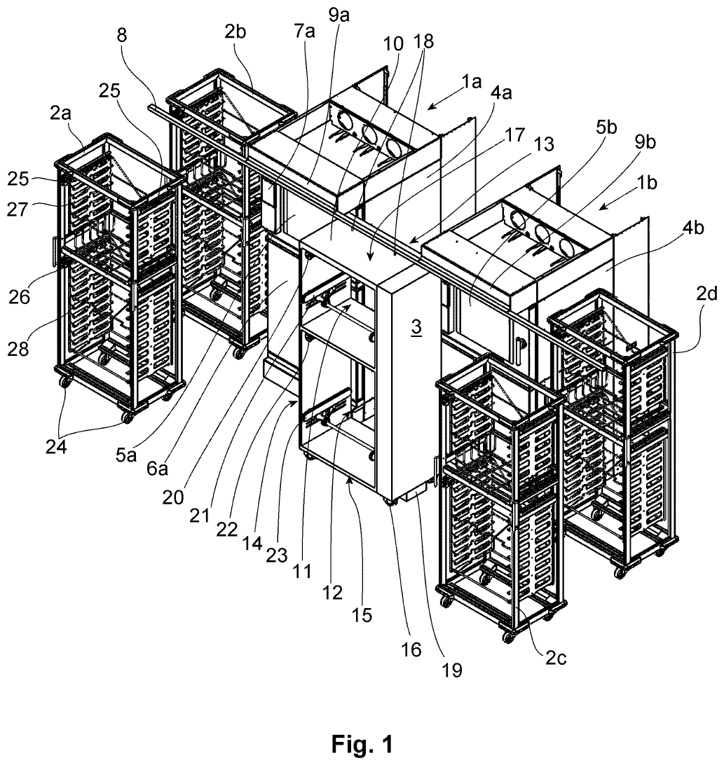

FIG. 1 shows a food treatment apparatus that includes two baking ovens 1a, 1b, four loading trolleys 2a, 2b, 2c, 2d associated with the two baking ovens 1a, 1b, and a transfer trolley 3. The two baking ovens 1a, 1b and the loading trolleys 2a, 2b, 2c, 2d are each identical in construction.

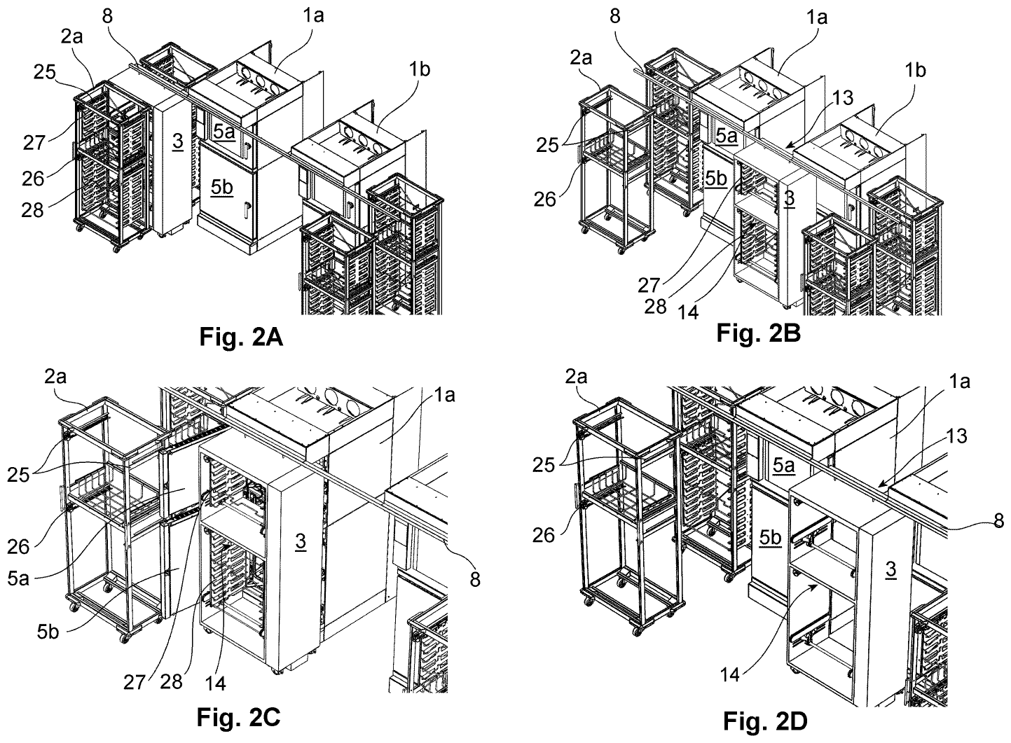

The baking ovens 1a, 1b shown in FIGS. 1 and 2A-2D are store ovens or production baking ovens commonly used in bakeries or in bakery factories. In the embodiment shown, the baking ovens 1a, 1b each include a housing 4a, 4b in which two baking chambers are arranged one above the other, and two doors 5a, 6a, 5b, 6b to the baking chambers arranged on the front side of the ovens, respectively. The doors 5a, 6a, 5b, 6b are closed during the baking process and can be opened and closed automatically for inserting the dough pieces and removing the baked products.

FIG. 1 also shows two control panels 7a, 7b with a display screen arranged at the front of the baking ovens 1a, 1b. The control panels 7a, 7b can be used to enter parameters of the baking processes (e.g., baking sequence, duration, temperature, steaming), which are then displayed for control via the display screen of the control panels 7a, 7b. It is also possible to control the baking ovens 1a, 1b remotely via data links. The baking ovens 1a, 1b are positioned spaced apart side by side with the same orientation. The doors 5a, 6a, 5b, 6b thus face in the same direction.

A straight rail 8 is arranged in front of the baking ovens 1a, 1b, which repre-sents a guiding device for the transfer trolley 3. With respect to the baking ovens 1a, 1b arranged next to each other, the rail 8 runs horizontally and transversely and has the same distance to each baking oven 1a, 1b. The rail 8 is arranged on a respective overhang 9a, 9b attached to the upper edge of the oven fronts, which is formed by the steam hood. In the transverse direction, the rail 8 projects to the left and right of the baking ovens 1a, 1b by a distance greater than the width of the transfer trolley 3. Along the rail 8, the transfer trolley 3 can be moved horizontally in the transverse direction to the baking ovens 1a, 1b.

The transfer trolley 3 has a frame 10 with an upper support portion 11 and a lower support portion 12. The dimensions of the frame 10 are matched to the dimensions of the baking ovens 1a, 1b such that a first open side 13 and a second open 14 side of the frame 10 are substantially congruent with the front of the baking ovens 1a, 1b. Further, the size of the upper support portion 11 is approximately the same as the size of the upper doors 5a, 5b of the baking ovens 1a, 1b and the size of the lower support portion 12 is approximately the same as the size of the lower doors 6a, 6b. Rollers 16 are arranged on a downwardly facing bottom surface 15 of the frame 10. The rollers 16 are used to move the frame 10 on the floor. Furthermore, on an upwardly facing top surface 17 of the frame 10, a fastening mechanism 18 is provided for further rollers (not shown) which run in the rail 8. When the transfer trolley 3 is driven by a drive 19 arranged on the floor surface 15, the transfer trolley 3 is guided along the rail 8 via the rollers mounted on the fastening mechanism 18, so that the transfer trolley 3 can be moved automatically in the horizontal transverse direction.

The lateral walls of the frame 10 of the transfer trolley 3 are closed, so that the frame 10 can also be referred to as a housing. However, the frame 10 could also be designed to be open as, for example, in the case of the loading trolleys 2a-2d.

In each of the upper and lower support portions 11, 12 of the transfer trolley 3, a loading rack 27, 28 can be accommodated, as shown for example in FIG. 2B. For moving the loading racks 27, 28, the transfer trolley 3 has an upper support device 20 and an upper actuator 21 in the upper support portion 11 and a lower support device 22 and a lower actuator 23 in the lower support portion 12. The support devices 20, 22 are identical and are each formed as a pair of guide rails, which are respectively attached to the opposite vertical inner sides of the frame 10. The support devices 20, 22 support the load of the loading racks 27, 28 in the transfer trolley 3 and allow the loading racks 27, 28 to slide in a longitudinal direction through the first and second open sides 13, 14 of the frame 10. The longitudinal direction is perpendicular to the transverse direction. The actuators 21, 23 are also identical to each other. The actuators 21, 23 are designed to move the loading racks through the first or the second open side 13, 14 along the pair of guide rails 20, 22 into or out of the support portions 11, 12 of the transfer trolley 3. Details of the support devices 20, 22 and actuators 21, 23 are described further below.

The four loading trolleys 2a, 2b, 2c, 2d are identical in construction. The following description of the loading trolley 2a is therefore applicable to the other loading trolleys 2b, 2c, 2d. The loading trolley 2a has a supporting frame, at the bottom of which rollers 24 are arranged for manually moving the loading trolley 2a on the floor. An upper second receiving device 25 and a lower second receiving device 26 are provided in the loading trolley 2a, which—like the support devices 20, 22 of the transfer trolley 3—are designed as pairs of guide rails 25, 26. The pairs of guide rails 25, 26 are attached to two opposing inner sides of the support frame of the loading trolley 2a and are aligned in the longitudinal direction with the upper and the lower pair of guide rails 20, 22 of the transfer trolley 3, respectively. The upper pair of guide rails 25 carries an upper loading rack 27 and the lower pair of guide rails 26 carries a lower loading rack 28. The loading racks 27, 28 can be pushed out of the loading trolley 2a in the longitudinal direction manually or with the actuator 21, 23. For example, product carriers such as baking trays (not shown) with baked goods can be inserted into the loading racks 27, 28. It is also possible for a plurality of non-identical loading trolleys to be used. For example, open-design loading trolleys and closed-design loading trolleys may be provided. It is important in the case of the loading trolleys that loading racks or product carriers arranged therein can be transferred into or out of the transfer device via one side from the loading trolleys.

In FIG. 1, the loading trolleys 2a, 2b, 2c, 2d are each shown in a transfer position. The transfer positions are predetermined positions of the loading trolleys 2a, 2b, 2c, 2d in which the guide rails 25, 26 of the loading trolleys 2a, 2b, 2c, 2d are aligned with the guide rails 21, 22 in the transfer trolley 3 when the latter is aligned with the respective loading trolley 2a, 2b, 2c, 2d. In the transfer position, the rollers 24 under the loading trolleys can be locked by a brake or other locking device (not shown). For the transfer of the loading trolleys 27, 28, the upper pairs of guide rails 25 and 20 and the lower pairs of guide rails 26 and 22 are each of the same design.

Of course, the treatment device can also have more or fewer baking ovens and/or more or fewer loading trolleys with second receiving devices than shown in FIG. 1. Treatment units other than baking ovens may also be present.

In FIGS. 2A, 2B, 2C and 2D, the treatment device of FIG. 1 is shown in different states during a loading process of the baking oven 1a. FIG. 2A shows the treatment device in a first state, in which the transfer trolley 3 has been moved to the transfer positions of the loading trolleys 2a and 2b by automatic travel along the rail 8. In the position of the transfer trolley 3 shown in FIG. 2A, the loading racks 27, 28 can be moved into the transfer trolley 3 from the loading trolleys 2a or 2b positioned and locked in the adjacent transfer positions. For this purpose, a first position measuring sensor (not shown) arranged on the transfer trolley 3 and/or on the rail 8 first determines whether at least one of the loading trolleys 2a, 2b is arranged in the transfer position, whether the transfer trolley 3 is in the position adjacent thereto, and whether at least one loading rack 27, 28 is accommodated in a loading trolley 2a, 2b or the transfer trolley. When this condition is satisfied, a control unit for controlling the actuators 21, 23 (not shown) can operate the actuators 21, 23, and the transfer of the loading rack(s) 27, 28 from the at least one loading trolley to the transfer trolley 3 is performed automatically. When two loading trolleys, each with at least one loading rack 27, 28, are positioned in the transfer position, the control unit for controlling the actuators 21, 23 selects the loading rack(s) 27, 28 currently to be transferred automatically or according to information about the loading of the loading racks. Signals from the first position measurement sensor and the loading information can be transmitted to the control unit by radio, for example.

FIG. 2B shows the treatment device in a second state after the loading racks 27, 28 have been transferred from the loading trolley 2a to the transfer trolley 3. The transfer trolley 3 has been moved along the rail 8 towards a first waiting position. The transfer trolley 3 occupies the first waiting position for a short time while one or both of the doors 5a, 6a, of the oven are swung open. When the transfer trolley 3 is in the first waiting position, the first position measurement sensor on the transfer trolley 3 registers the transfer trolley 3 being in the first waiting position and automatically sends an “open” signal to a control unit for controlling the doors 5a, 6a. The control unit controls a drive (not shown) for swinging open at least one of the doors 5a, 6a.

FIG. 2C shows the treatment device in a third state in which the doors 5a, 6a are open. Thus, loading openings that are closed by the doors 5a, 6a in FIGS. 2A and 2B are uncovered and by moving along the rail 8 the transfer trolley 3 can be positioned with the first open side 13 of the frame 10 adjacent to the loading openings of the oven 1a. The first position measurement sensor registers the loading position of FIG. 2C and again automatically sends the “transfer” signal to the control unit for controlling the actuators 21, 23. The loading racks 27, 28 can then be automatically moved by the actuators 21, 23 through the first open side 13 of the transfer trolley 3 in the longitudinal direction into the baking chambers of the oven 1a. Further details on the process of loading by the actuators 21, 23 are described below.

FIG. 2D shows the treatment device in a fourth state, in which the loading racks 27, 28 have been transferred from the transfer trolley 3 into the baking oven 1a. The transfer trolley 3 has been moved away from the loading position along the rail 8, towards the waiting position. The first position measurement sensor automatically sends a “close” signal to the control unit for controlling the doors 5a, 6a.

The transfer trolley 3 can either remain in the waiting position of FIG. 2D until the baking process is completed and then carry out unloading of the baking oven 1a in the reverse order to loading. Alternatively, the transfer trolley 3 may perform loading or unloading of the baking oven 1b. For example, the baking oven can be loaded with the loading racks 27, 28 of the loading trolleys 2b, 2c, or 2d, or loading racks 27, 28 already arranged in the baking oven 1b can be removed and transferred to the loading trolley 2a.

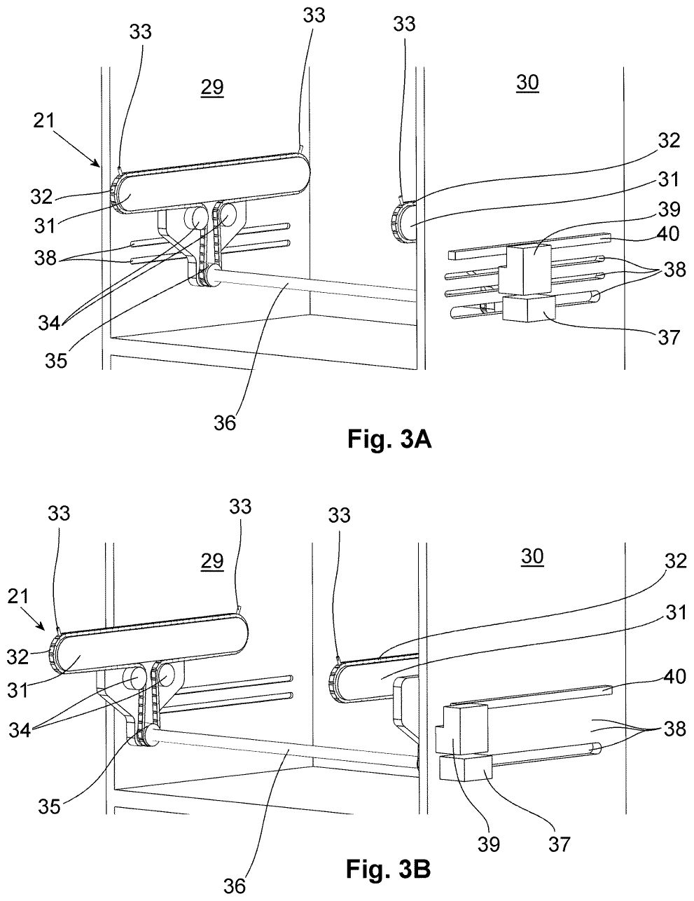

In FIGS. 3A and 3B, the upper actuator 21 arranged on the transfer trolley 3 is shown in detail. The lower actuator 23 has an identical design to the upper actuator 21. In FIG. 3A, the actuator 21 is shown in a first position in the middle of the transfer trolley 3, and in FIG. 3B, the actuator 21 is shown in a second position in which the actuator 21 projects beyond the second open side 14 of the transfer trolley 3.

The actuator 21 is arranged on two side walls 29, 30 of the frame 10, which are opposite each other in the transverse direction, and is essentially mir-ror-symmetrical. Two identical belt guides 31 of the actuator, each guiding a drive belt 32 with drivers 33, are arranged on the inner surfaces of the side walls 29, 30 of the transfer trolley 3. The drive belts 32 are guided around belt pulleys 34 and are each driven by a drive belt pulley 35. The drive belt pulleys 35 are attached to a coupling shaft 36 supported between the belt guides 31, and the coupling shaft 36 is drivable by a first actuator drive 37. When the coupling shaft 36 performs a rotational movement caused by the first actuator drive 37, the rotational movement is transmitted via the drive belt pulleys 35 to the drive belts 32 on both side walls 29, 30 of the transfer trolley 3, so that the drivers 33 are driven synchronously. The drivers 33 are designed in the present case as pins projecting perpendicularly from the drive belt 32, which can engage behind abutments on the upper loading rack 27. When the drivers 33 engage behind the abutments on the loading rack 27, the loading rack 27 can be moved along the belt guide 31 together with the drivers 33. This allows the loading rack 27 to be pushed or pulled from the pair of guide rails 25 of the loading trolley 2a onto the pair of guide rails 20 of the transfer trolley 3. As an alternative to the belts and pulleys, the actuator 21 can of course also have a chain and toothed wheels which cause the driving of the drivers.

Furthermore, guide grooves 38 oriented in the longitudinal direction of the transfer trolley 3 are provided in the side walls 29,30 of the frame 10, in which the first actuator drive 37 and a second actuator drive 39 are dis-placeably mounted. In the present case, the actuator drives 37, 39 are arranged on the outer surface of the side 29 and/or 30. The second actuator drive 39 may have a gear wheel whose teeth engage a toothed rack 40 oriented parallel to the guide grooves 38. When the gear is driven by the second actuator-drive 39, the second actuator-drive 39 and the belt guides 31 rigidly connected thereto via the coupling shaft 36 are displaced along the toothed rack. This displacement is illustrated by the different positions of the actuator 21 in FIG. 3A and FIG. 3B. Due to the mechanical connection of the belt guides 31 by the coupling shaft 36, it is sufficient if a first and a second actuator drive 37, 39 are provided at one side of the actuator 21. Alternatively, a first and a second actuator drive 37, 39 may be provided on both sides 29, 30. In this case, a connection to the coupling shaft 36 may be omitted. Further alternatively, the actuators 21, 23 and the drives 37, 39 of the actuators 21, 23 may be arranged at any other positions in the center or on the side of the transfer trolley 3. It is only necessary to ensure that the actuator drives can interact with the transfer trolley in such a way that the loading rack can be displaced.

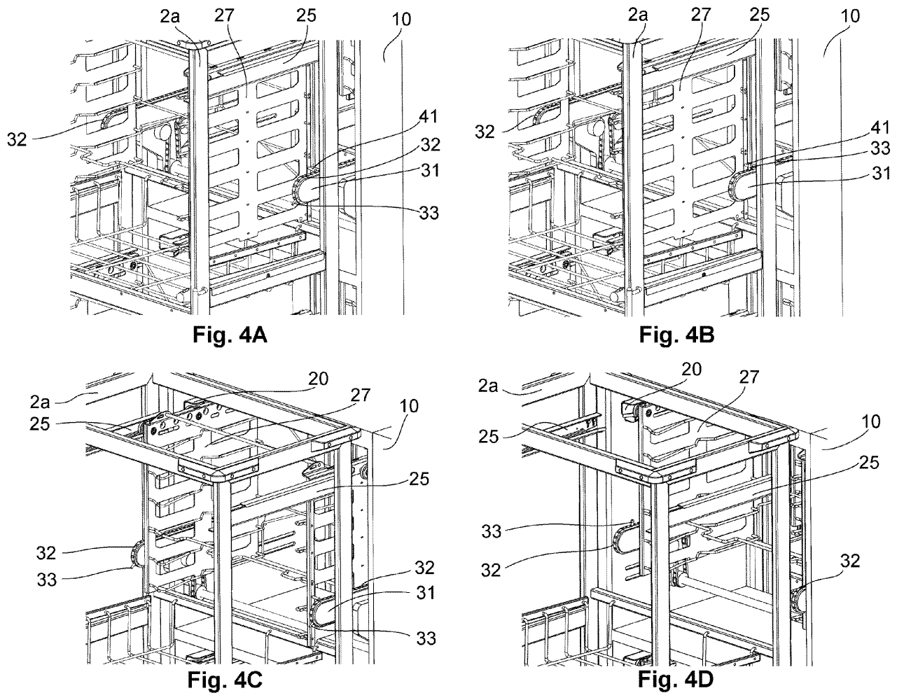

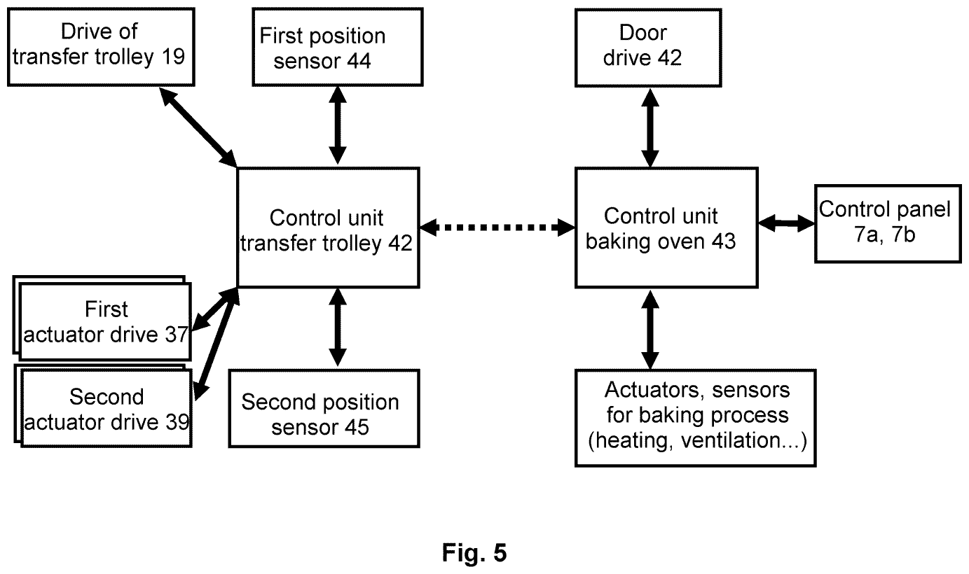

In FIGS. 4A, 4B, 4C, 4D, a transfer of the upper loading rack 27 from the loading trolley 2a in the transfer position to the transfer trolley is shown in detail. The transfer of the lower loading rack 28 and the transfer from the other loading trolleys 2b, 2c, 2d functions in the same manner.

When the transfer trolley 3 has approached the transfer positions of the loading trolley 2a, the first position measurement sensor sends the “transfer” signal to the control unit for controlling the actuator 21, whereupon the actuator drives 37, 39 effect the transfer.

FIG. 4A shows the beginning of the transfer, with rollers of the loading rack 27 resting on the upper pair of guide rails 25 of the loading trolley 2a and supporting the loading rack 27. The actuator 21 has been moved longitudi-nally by the second actuator drive 39 through the second open side 14 of the transfer trolley 3 into the second loading trolley 2a. The position of the actuator 21 shown corresponds to the position shown in FIG. 3B. The drive belts 32 are adjusted so that the drivers 33 protrude in the longitudinal direction and can thus be moved past abutments 41 of the loading rack 27. A second position measurement sensor (not shown) continuously detects the position of the actuator 21 in relation to the transfer trolley 3 and the position of the drive belts 32 in the belt guides 31, and transmits the positions to the control unit for controlling the actuator 21. When the actuator 21 has assumed the position shown in FIG. 4A, the second position measurement sensor sends a signal to the control unit for controlling the actuator, whereupon the first actuator drive 37 drives the drive belts 32 in such a way that the drivers 33 run around the belt guides 31 until the drivers 33 project up-wards and engage with the abutments 41, as shown in FIG. 4B.

Continued drive of the drive belt 32 using the two drive belt pulleys 35 coupled via the coupling shaft 36 (FIGS. 3A and B), the drivers 33 engaged with the abutments 41 pull the loading rack 27 toward the transfer trolley 3 until the transfer trolley 3 is completely above the actuator, as shown in FIG. 4C. In the position of FIG. 4C, the loading rack 27 is partially supported by the pair of guide rails 25 of the loading trolley 2a and partially supported by the pair of guide rails 20 of the transfer trolley 3.

Subsequently, the second actuator drive 39 is activated again and pulls the belt guides 31 completely into the transfer trolley 3, as shown in FIG. 4D. At the same time, the loading rack 27 held by the drivers 33 above the belt guides 31 of the actuator 21 is also pulled completely into the transfer trolley 3 and rests completely on the pair of guide rails 20 of the transfer trolley 3.

The transfer of the loading rack from the transfer trolley 3 to the baking oven 1a is performed in reverse. First, the actuator 21 with the loading rack 27 is moved through the first open side 13 of the transfer trolley 3 by the second actuator drive 39. When the actuator 21 has assumed an end position in which the actuator 21 protrudes maximally out of the transfer trolley 3 and into the baking chamber of the baking oven 1a, the control unit for the actor activates the first actuator drive 37, which moves the drivers 33 into the baking chamber via the drive belt pulleys 35 and the drive belts 32, which in turn displace the loading rack 27 completely into the baking oven 1a. The actuator is then retracted back into the transfer trolley 3 and the oven door can be closed.

The transfer of the loading rack 27 out of the baking oven 1a into the transfer trolley 3 functions in the same manner as the transfer from the loading trolley 2a into the transfer trolley 3. Subsequently, the transfer trolley 3 moves again into a position in which the transfer trolley 3 is aligned with a loading trolley (e.g. 2a). In this position, the transfer from the transfer trolley 3 to the loading trolley 2a takes place in the same manner as the previously described transfer from the transfer trolley 3 to the baking oven 1a.

It is apparent that the actuator 21 can transfer a loading rack located in the transfer trolley 3 to both sides of the transfer trolley 3 to a receiving device located at either side of the transfer trolley 3. The same applies to the second actuator 23 of the transfer trolley.

It should be noted that the design and mode of operation of the actuator described here is explained only by way of example. The actuator can also be implemented in other ways, for example as a swivel arm arranged in the transfer trolley that can be swiveled out of the transfer trolley, or as a longi-tudinally displaceable arm that can be pushed out of the transfer trolley and whose end cooperates with a receiving part on the loading rack.

FIG. 5 shows a block diagram in which the communication of the electronic functional elements of the treatment device is shown as an example. The arrows indicate communication paths. Here, the communication between the control unit of the transfer trolley 42 and the control unit of the baking oven 43 can be wireless, which eliminates the need to wire the control units that are movable relative to each other. The control units of the transfer trolley 42 and the baking oven 43 are preferably connected to a communication network via which the control units of the transfer trolley 42 and the baking oven 43 can communicate with each other and with other equipment and a central computer of the baking system.

The control unit of the transfer trolley 42 controls the first and second actuator drives 37, 39 of the actuators 21, 23 as well as the travel drive of the transfer trolley 19. The control unit 43 of the oven 1a controls the entire oven operation, including the door drive for the oven door. It is usually equipped with the control panel 7a, but can also be controlled remotely via the aforementioned communication network or a remote control unit (not shown).

A first position measurement sensor 44 determines whether at least one loading trolley 2a, 2b, 2c, 2d is arranged in the transfer position and whether at least one loading rack 27, 28 is received in a loading trolley 2a, 2b, 2c, 2d. At least one loading rack 27, 28 can be arranged on the transfer trolley 3, on the loading trolley or trolleys 2a, 2b, 2c, 2d, or also stationary in the transfer device. In addition to the position of the loading trolleys 2a, 2b, 2c, 2d, information about the charge of the loading racks therein can also be transmitted via the communication network, in particular to the control unit of the baking oven 43, in order to operate the control unit optimally.

The second position measurement sensor 45 for measuring the position of the actuator 21 in relation to the transfer trolley 3 and the position of the drive belts 32 in the belt guides 31 also continuously transmits the measurement results to the control unit for controlling the actuators 21, 23.

Using the position measuring sensors 44, 45 and the controls 42, 43, the moving parts (transfer trolley 3, loading trolleys 2a, 2b, 2c, 2d, oven doors 5a, 6a, actuators 21, 23) can be moved in such a way that the transfer of the loading racks between the ovens 1a, 1b and the loading trolleys is fully automatic, without collisions of moving parts.

The features of the invention disclosed in the present description, in the drawings as well as in the claims may be essential, both individually and in any combination, for the realization of the invention in its various embodiments. The invention is not limited to the embodiments described. It may be varied within the scope of the claims and with due regard to the knowledge of the person skilled in the art.
29 Side wall of the frame
30 Side wall of the frame
31 Belt guide of the actuator
32 Drive belt
33 Driver
34 Belt pulleys
35 Drive belt pulleys
36 Coupling shaft
37 first actuator drive
38 Guide grooves
39 second actuator drive
40 Toothed Rack
41 Abutment
42 Transfer trolley control unit
43 Control unit of the oven
44 first position measuring sensor
45 Second position measuring sensor
46 Door drive

1. A Transfer device for loading and/or unloading a food treatment unit, comprising:
a movable transfer trolley which has a support device for at least one loading rack or for at least one product carrier;
a drive coupled to the transfer trolley; and
an actuator arranged on the transfer trolley and configured to move the at least one loading rack or the at least one product carrier into a receiving device, located on a first side of the transfer trolley of the food treatment unit and to remove the at least one loading rack or the at least one product carrier therefrom, wherein the transfer trolley and the actuator are configured to additionally move the at least one loading rack or the at least one product carrier into at least one second receiving device, located on a second side of the transfer trolley, and to remove the at least one loading rack or the at least one product carrier therefrom.

2. The transfer device according to claim 1, further comprising:
a guiding device which guides the transfer trolley along a travel path of the transfer trolley.

3. The transfer device according to claim 2, wherein the guiding device includes at least one of: a rail; a conductor track; and/or a navigation system.

4. The transfer device according to claim 1, wherein the transfer trolley includes a frame, having a first side and a second side that are open and facing each other.

5. The transfer device according to claim 1, wherein the actuator includes at least one drive and at least one driver.

6. The transfer device according to claim 5, wherein at least one sensor and a control unit is are assigned to the actuator.

7. A treatment device for food, comprising:
a food treatment unit having at least one treatment chamber with a receiving device for receiving at least one loading rack or product carrier;
at least one automatically opening and closing treatment chamber door; and
at least one second receiving device associated with the food treatment unit that receives the loading rack or product carrier; and
a transfer device having a movable transfer trolley which has a support device for the loading rack the or the product carrier, a drive coupled to the transfer trolley; and an actuator arranged on the transfer trolley and configured to move the loading rack or the product carrier into the receiving device, located on a first side of the transfer trolley of the food treatment unit and to remove the loading rack or the product carrier therefrom, wherein the transfer trolley and the actuator are configured to additionally move the loading rack or the product carrier into at least one second receiving device, located on a second side of the transfer trolley, and to remove the at least one loading rack or the at least one product carrier therefrom.

8. The treatment device according to claim 7, wherein the second receiving device is arranged on at least one of the following: a loading trolley; a loading trolley of a cooling unit; and/or a loading trolley of a proofing unit.

9. The treatment apparatus according to claim 7, wherein the at least one second receiving device is assigned a transfer position in which the second receiving device can be positioned on the first or second side of the transfer trolley and in which the loading rack or the product carrier can be moved into the second receiving device and removed therefrom.

10. The treatment device according to claim 9, wherein the second receiving device is displaceable and lockable in a transfer position.

11. A method for automatic loading and unloading of a food treatment unit with a first receiving device, comprising:
positioning a second receiving device in a transfer position;
automatically moving a transfer trolley to the transfer position;
transferring a loading rack or a product carrier between the transfer trolley and the second receiving device in a transfer position with an actuator arranged on the transfer trolley;
automatically opening or closing of a door of the treatment chamber provided on the treatment unit;
automatically moving the transfer trolley into a loading position; and
transfer of transferring the loading rack or the product carrier between the treatment unit and the transfer trolley in the loading position the actuator arranged on the transfer trolley.

12. The method according to claim 11, wherein the transfer of the loading rack or product carrier by the actuator takes place via at least two different sides of the transfer trolley.

13. The transfer device according to claim 2, wherein the transfer trolley includes a frame having a first side and a second side that are open and facing each other.

14. The transfer device according to claim 13, wherein the actuator includes at least one drive and at least one driver.

15. The transfer device according to claim 14, wherein at least one sensor and a control unit are assigned to the actuator.

16. The transfer device according to claim 3, wherein the transfer trolley includes a frame having a first side and a second side that are open and facing each other.

17. The transfer device according to claim 16, wherein the actuator includes at least one drive and at least one driver.

18. The transfer device according to claim 17, wherein at least one sensor and a control unit are assigned to the actuator.

19. The treatment apparatus according to claim 8, wherein the at least one second receiving device is assigned a transfer position in which the second receiving device can be positioned on the first or second side of the transfer trolley and in which the loading rack or the product carrier can be moved into the second receiving device and removed therefrom.

20. The treatment device according to claim 19, wherein the second receiving device is displaceable and lockable in a transfer position.
